(19) United States
(12) Patent Application Publication
(10) Pub. No.: US 2006/0272520 A1
(43) Pub. Date: Dec. 7, 2006

(54) Power paper detailer

(75) Inventors: John Nottingham, Bratenahl, OH (US); John Spirk, Gates Mills, OH (US); Patrick Brown, Mantua, OH (US); Robert Dorsey, Columbia Station, OH (US); Trevor Jackson, Kirtland, OH (US); Carolyn McNeeley, Brunswick Hills, OH (US)

Correspondence Address: CALFEE HALTER & GRISWOLD, LLP, 800 SUPERIOR AVENUE, SUITE 1400, CLEVELAND, OH, 44114, US

(73) Assignee: Nottingham-Spirk Design Associates, Inc., Cleveland, OH (US)

(21) Appl. No.: 11/361,915

(22) Filed: Feb. 24, 2006

Related U.S. Application Data
(60) Provisional application No. 60/687,595, filed on Jun. 3, 2005.

(51) Int. Cl. B31F 1/07; B44B 5/02; B44B 5/00

(52) U.S. Cl. 101/24; 101/23; 101/28; 101/30

(57) ABSTRACT

Disclosed is a paper detailer including a housing and a pair of rollers. The housing supports the rollers to be substantially parallel to each other and to be rotatable. At least one of the pair of rollers includes a template. A power source, for example, a battery, is electrically or mechanically connected to the pair of rollers. A piece of paper or other media is rolled between the rollers roll transfer a pattern formed by the template into the piece of paper.

### PRIORITY CLAIM

This application claims priority to U.S. Provisional Patent Application 60/687,595, filed Jun. 3, 2005, which is incorporated herein by reference, in its entirety.

### TECHNICAL FIELD

The present invention is directed to a tool for crimping, embossing, cutting, perforating, slitting and/or die cutting paper or other materials and, more particularly, to an electrically powered paper detailing tool.

### BACKGROUND OF INVENTION

There are currently several different cutting tools or implements and texture wheels for use with various crafts, such as scrapbooking. However, these devices are manually operated. Thus, these devices can prove difficult to use and can be a strain on the hands or arms of the user.

Furthermore, existing devices only have the capability of conveniently rendering one distinct pattern or design. Thus, if multiple patterns or designs are desired, a separate device is required to create each of these different patterns or designs.

### SUMMARY OF THE INVENTION

It is an object of this invention to provide a versatile and easy-to-use detailing device that makes the crimping, embossing, texturing, cutting, perforating, slitting, die-cutting, etc. of paper, ribbons and other materials a quick and easy process.

Various embodiments of the present invention are directed to electrically powered paper detailers that may be used in crafts, such as scrapbooking, to crimp, emboss, texture, and/or die-cut paper, ribbons, cardboard, fabric, photographs, foils, metals and other materials. One embodiment of the detailer generally includes a housing that supports a pair of rollers. At least one of the rollers may have a pattern that projects from or is defined within the surface of the roller. One roller may have a positive design, while the other roller has a corresponding negative design to reinforce the crimp, embossment, or die-cut shape created on the paper.

When a piece of paper or other material is passed through the rollers of the illustrated embodiment, the rollers rotate together. As the paper travels through the detailer, the rollers crimp, emboss, or die-cut the paper, thereby transferring the pattern from the roller to the paper or other material. In various embodiments of the detailer, the rollers are removable from the housing to allow for various rollers of different design to be used with the detailer to create various patterns.

An advantage of the detailer is the ease in which it can be used for embossing and die-cutting paper. Due to the ease with which the detailer can be used, the detailer can be operated by a wide range of users, from the very young to the elderly or even those who have health problems that limit the use of their hands, such as arthritis. Additionally, another advantage of the illustrated embodiment of the present invention is that the user may render different textures, designs, and patterns onto paper or other material with one detailer. Since various rollers each having the capability to produce different textures, designs or patterns may be used with the detailer of the illustrated embodiment, there is no need to purchase a different detailer to achieve different textures, patterns, or shapes. Another advantage of the detailer of the illustrated embodiment is that due to its compact size, the detailer is easily stored and transported.

### BRIEF DESCRIPTION OF THE DRAWINGS

FIG. 1 is a perspective view of one embodiment of paper detailer according to the present invention;

FIG. 2 is a front elevational view of a roller cartridge of the paper detailer shown in FIG. 1;

FIG. 3 is a bottom plan view of a roller cartridge of the paper detailer shown in FIG. 1;

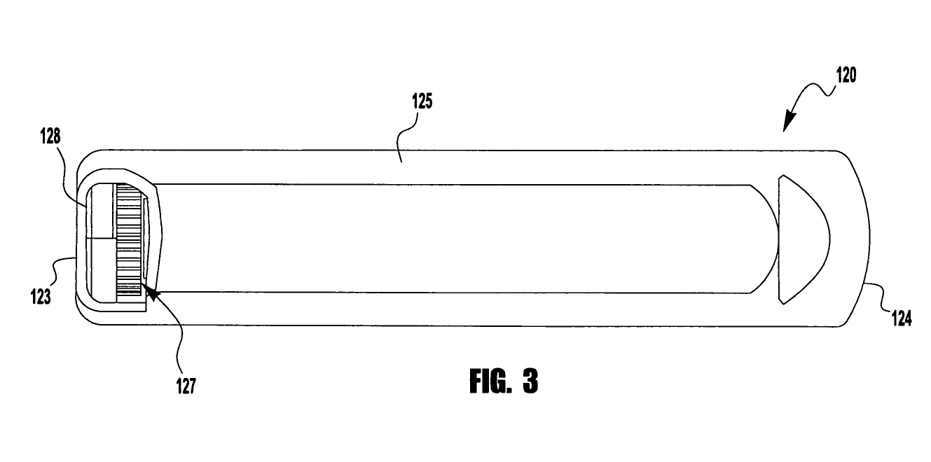

FIG. 4 is an exploded perspective view of the paper detailer shown in FIG. 1; and

FIG. 5 is a side elevational exploded view of the paper detailer shown in FIG. 1.

### DETAILED DESCRIPTION OF THE INVENTION

A complete understanding of the invention will be obtained from the following description when taken in connection with the accompanying drawing figures wherein like reference characters identify like parts throughout. For purposes of the description hereinafter, the terms “upper”, “lower”, “right”, “left”, “vertical”, “horizontal”, “top”, “bottom”, and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting.

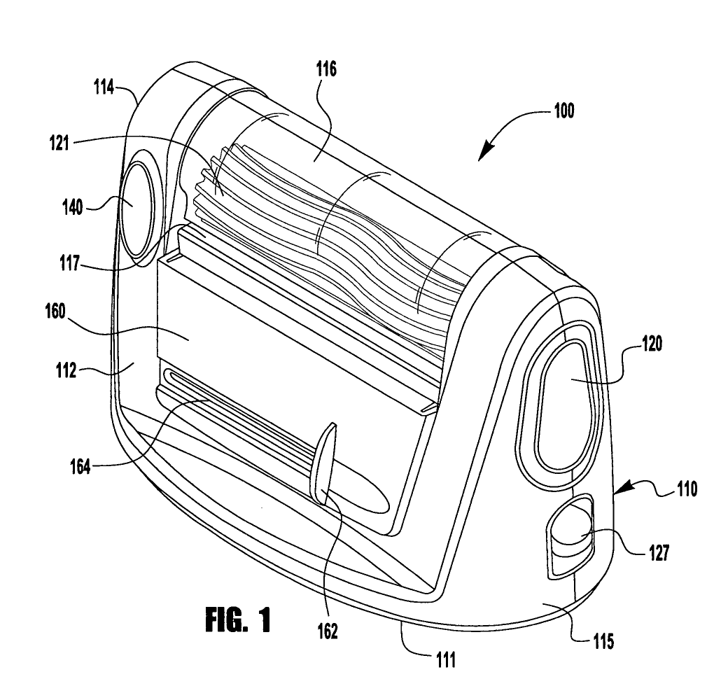

The present invention relates to a tool for crimping, embossing, and/or die cutting paper or other materials and, more particularly, to an electrically powered paper detailing tool. The invention is applicable to tools of varying constructions for crimping, embossing, and/or die cutting paper or other materials. As representative of the invention, FIG. 1 illustrates a paper detailer 100 in accordance with a first embodiment of the invention.

As shown in FIG. 1, the paper detailer 100 of the illustrated embodiment generally includes, among other things, a housing 110 and a roller cartridge 120 including a pair of rollers 121, 122. The housing 110 is preferably molded from plastic but other suitable materials could also be used. In the illustrated embodiment, the housing 100 has the general shape of a triangular prism. The upper, thinner portion of the triangular prism shaped housing of the illustrated embodiment is adapted to be easily grasped and held by the hand of the user both when the user is operating the detailer or picking it up and moving it. To further aid the user in grasping the detailer, one or more indentations could be defined within the housing to give the user a gripping surface as well as a place to rest their fingers or other portion of their hand. It should be apparent, however, that such indendations are not necessary and must not be present with every embodiment of the detailer. It should also be apparent to one skilled in the art, that the housing 100 could be shaped differently, for example the housing could have a generally rectangular or cylindrical shape. Finally, it should also be apparent that the housing 100 could be produced in various sizes.

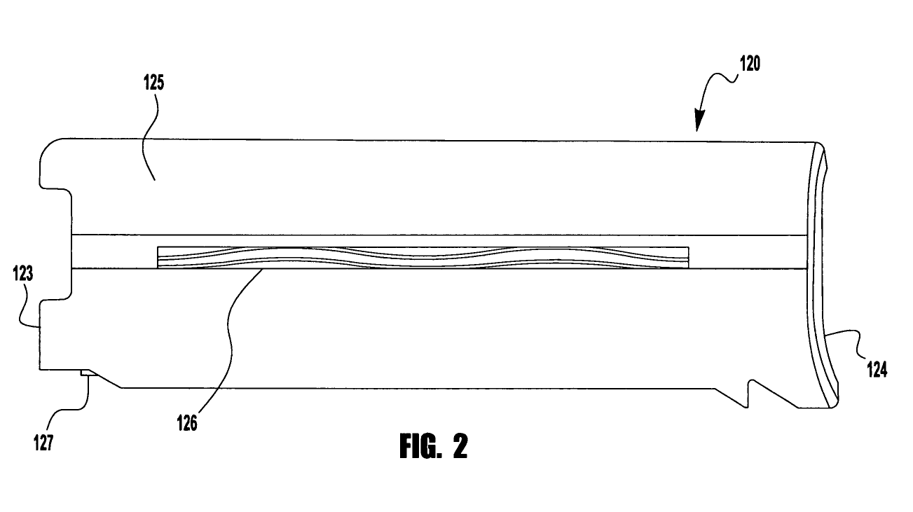

The configurations of the housing 110 is adapted to support and enclose other components of the detailer 100. In the illustrated embodiment, the housing has a generally bottom wall 111, a front wall 112, a back wall 113, and a pair of opposable side walls 114, 115 that extend from the bottom wall to form a partially closed space that encloses other components of the detailer. The housing also includes an opening 117 that permits paper to be inserted into and through the housing. In the illustrated embodiment, the opening is defined within both the front wall 112 and back wall 113. The detailer of the illustrated embodiment also includes a top cover 116. In the illustrated embodiment, a portion of the top cover 116 of the illustrated embodiment is translucent, thereby allowing the inner contents of the housing including the rollers 121, 122 to be visible from the exterior of the housing 110. It should be apparent to one skilled in the art that the housing 110 could consist of multiple parts assembled together or could have a one piece, unitary construction. In addition, all of the cover or a portion of the cover 116 or other portion of the housing could be translucent or transparent or the cover 116 or housing 110 could not include such a translucent or transparent section. In the illustrated embodiment, the housing 110 is formed of multiple parts, which are connected and secured to one another using inter-engaging tabs and slots, and screws inserted through screw holes. While the tabs slots, and screw holes are shown in the embodiment of FIG. 2, several other methods of assembling the housing 110 could be used, including but not limited to glue, different configurations of tabs, slots, screws, sonic welding other engagement means, and combinations thereof.

The detailer of the illustrated embodiment includes a roller cartridge 120 including a pair of rollers 121, 122. The roller cartridge 120 is adapted to be mounted and at least partially enclosed within the housing 110. In additional embodiments, the roller cartridge could be adapted to be completely enclosed within the housing. The roller cartridge 120 of the illustrated embodiment has the general shape of an irregular cylinder; however the roller cartridge could be shaped differently in various embodiments. For example, the roller cartridge 120 could have a rectangular shape. The roller cartridge 120 of the illustrated embodiment is preferably molded from plastic but other suitable materials could also be used.

The roller cartridge 120 has a pair of end walls 123, 124 and a side wall 125 that to form a partially closed space that encloses the rollers 121, 122 and the other contents of the roller cartridge 120. The rollers 121, 122 are mounted within the roller cartridge 120 such that each roller is rotatable around one of a pair of parallel axes. An opening 126 is defined within the side wall 125 of the roller cartridge of the illustrated embodiment to permit paper or other material to enter the roller cartridge and contact the rollers 121, 122 when the roller cartridge is mounted within the housing 110 of the detailer 100, yet the opening is adapted to be small enough so as to prevent the fingers of a user or other objects from entering into the roller cartridge. It should be apparent that the opening in the roller cartridge could be configured differently in additional embodiments. The roller cartridge 120 of the illustrated embodiment includes a gear assembly 127 that is accessible via the exterior of the roller cartridge 120 by an opening 128 defined within one or more of the end walls 123, 124 and/or the side wall 125 of the roller cartridge. The gear assembly mechanically engages with at least one of the rollers 121, 122.

The illustrated embodiment of the detailer 100 includes a pair of rollers 121, 122; however it should be apparent that different numbers of rollers could be provided with various embodiments of the detailer 100. For example, the detailer 100 could include only one roller. One of the pair of rollers 121,122 could includes a template. The template is a shape or design that will be cut or pressed into or transferred onto a paper or other suitable material. For example, the pair of rollers 121,122 may be crimping rollers, embossing rollers, die cutting rollers, or any combination of crimping, embossing, die cutting rollers or any other type of roller that renders or transfers a pattern onto paper or other material. In addition, one or more of the rollers may include one or more cutting blades having a wheel shape or other shape. The cutting blades may possess a pattern. A roller may have one cutting blade or multiple cutting blades. If a particular roller includes multiple cutting blades, each blade may possess the same pattern or they each may possess a different pattern from each other or be provided in various combinations.

One roller of the pair of rollers 121, 122 may have a positive design, while the other roller has the negative design to reinforce the crimp, embossment, cut, slit, perforation or die-cut shape created on the paper. Conversely, both of the rollers 121, 122 could each include a different pattern. In additional embodiments, one of the rollers may include a template or pattern while the other roller is simply a plain surface. Also, in additional embodiments one of the rollers may include a template or pattern while the other roller has a padded surface. This padded surface helps to increase the effectiveness of the pattern or template rendering process and/or may also serve to prolong the life of the template or pattern. For example, if one of the rollers includes a cutting blade, the other roller may include a padded surface that either has ridges defined within it which correspond to the shape of the cutting blade or is adapted to be cut by the cutting blade. In this manner, the padded surface of the roller ensures that the blade cuts completely through the paper or other media that is passed through the paper detailer. The padded surface also helps to prolong the life of the cutting blade, as the cutting blade could tend to grow dull more quickly if it was cutting against a hard surface.

The rollers could also be adapted to transfer ink, glitter or other material onto the paper or other material. The rollers that include a template or pattern could include a continuous pattern that runs along the entire length of the roller or they could include a template or pattern that only exists on a portion of the roller. Additional embodiments, could include rollers that include multiple templates or patterns that each occupy a portion of a single roller. Finally, additional embodiments of the detailer could include rollers that include countless combinations of different patterns, templates, cutters, slitters, perforators, crimpers, embossers, die cutters, ink, glitter, or adhesive transferring pattern, etc., each occupying a portion of a single roller.

The rollers 121, 122 of the present embodiment are permanently enclosed within the roller cartridge 120. In the illustrated embodiment, a ejection button 127 is provided to allow the user to eject the cartridge from the paper detailer. It should be apparent to one skilled in the art that various types of ejection mechanisms could be utilized to accomplish this. To achieve the desired pattern of crimp, embossment, or die-cut shape, etc. that will be created on the paper or other material, the user will be able to mount different roller cartridges 120 within the housing 110 that include various combinations of rollers 121, 122. For example, to render a certain crimped pattern into a piece of paper, the user will locate a roller cartridge 120 that includes rollers 121, 122 which possess the desired pattern and insert the roller cartridge 120 into the housing 110. It should be apparent to one skilled in the art that an endless variety of different patterns could be cut by various die-cutting rollers that could be used with the detailer. Various roller cartridges 120 will be provided with the detailer 100 or will be available separately from the detailer. It should also be apparent to those skilled in the art that the rollers could be removable from the roller cartridge 120 such that various rollers could be exchanged in and out of one roller cartridge 120. Also the detailer 100 could be provided without a roller cartridge 120. The rollers 121, 122 could simply be either removably or permanently mounted directly within the housing 110. Finally, the paper detailer 100 could be adapted to include multiple roller cartridges 120 or multiple sets of rollers and the multiple openings could be defined within the housing 110 of the paper detailer to allow for paper or other media to be inserted into each of the multiple cartridges or multiple pairs of rollers.

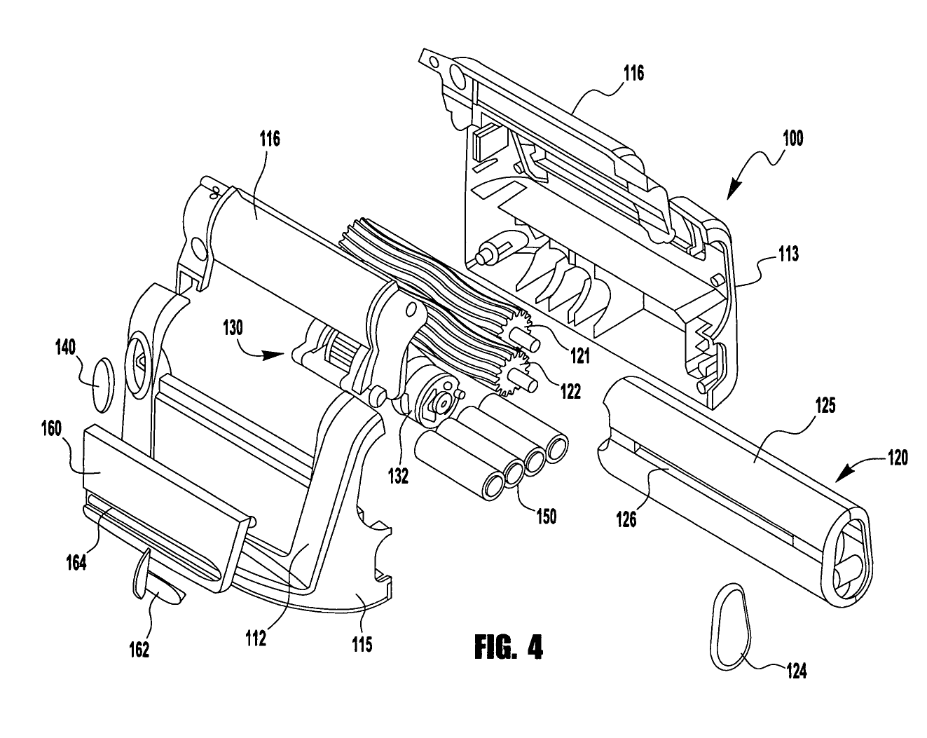

According to various embodiments of the paper detailer 100, the rollers 121, 122 are driven to rotation by a drive mechanism 130. As illustrated in representative FIG. 4, the drive mechanism 130 is housed within the housing 110, and as such, is integrated within the device. Of course, one of ordinary skill will appreciate that the drive mechanism 130 could be contained as a module within a separate housing (not shown), and engaged with the rollers 121, 122 of the detailer 100 to drive rotation of the rollers 121, 122. Such a modular drive mechanism could be engaged with various modules that each perform a different function and possess different features, such as a paper or media cutter, a paper or media crimper, a paper or media embosser, etc.

According to some embodiments, the detailer 100 of the illustrated embodiment includes a drive mechanism that includes an electric motor 132. In alternate embodiments, the detailer 100 could also manually powered, such as by a hand-crank or other device. The detailer 100 could also include both an electric motor and an apparatus that manually drives the detailer, such as a hand crank. In this manner, the detailer could be both electronically and manually powered. Accordingly, the device could then be manually driven if a power supply is not available or if the detailer becomes jammed and the user wished to manually drive the rollers 121, 122 to rotate in order to remove the material jamming the device.

Referring again to FIG. 4, the electric motor 132 in accordance with the depicted embodiment is supported and enclosed within the housing 110. The electric motor 132 has a generally cylindrically shape and a protruding output shaft (not shown) that rotates when the motor 132 is activated. Multiple types and configurations of electrical motors may be used with the detailer 100. Accordingly, various combinations of motor components, including motor cage sizes, wire sizes, number of wire winds, and magnet types may be used according to the present invention. The electric motor 132 rotates its output shaft at between 10,000 revolutions per minute to 25,000 revolutions per minute when no load is placed on the electric motor 132. According to the present invention, the electric motor rotates its output shaft at 10000, 10250, 10500, 10750, 11000, 11250, 11500, 11750, 12000, 12250, 12500, 12750, 13000, 13250, 13500, 13750, 14000, 14250, 14500, 14750, 15000, 15250, 15500, 15750, 16000, 16250, 16500, 16750, 17000, 17250, 17500, 17750, 18000, 18250, 18500, 18750, 19000, 19250, 19500, 19750, 20000, 20250, 20500, 20750, 21000, 21250, 21500, 30250, 22000, 22250, 22500, 22750, 23000, 23250, 23500, 23750, 24000, 24250, 24500, 24750, or 25000 revolutions per minute when no load is placed on the electric motor 132. The torque of the output shaft of the electric motor 132 is from 4 to 25 MilliNewton Meters. According to various embodiments of the present invention, the electric motor torque is 4, 5, 6, 7, 8, 9, 10, 11, 12, 13, 14, 15, 16, 17, 18, 19, 20, 21, 22, 23, 24, 25 MilliNewton Meters, or fractions thereof.

The drive mechanism 130 of the illustrated embodiment of the detailer 100 also includes a gear assembly 135, also supported and enclosed within the housing 110. In the illustrated embodiment, the gear assembly 135 is fashioned out of plastic, but other suitable materials, such as metal, or combinations of metal and plastic could be used. The gear assembly 135 mechanically connects the electric motor 132 with the gears, which in turn are connected to and drive rotation of the pair of rollers 121, 122. When the electric motor 132 is activated, the gear assembly 135 drives the rollers 121, 122. The gear assembly 135 of the illustrated embodiment includes a series of optional step-down gears, which are adapted to increase the torque output of the electric motor. It should be apparent to one skilled in the art that several configurations of gear assemblies could be utilized. Additionally, the electric motor 132 could be directly engageable with the rollers 121, 122.

In some embodiments, a gear assembly 135 comprises reduction gears. As used herein in the context of gears, the term “reduction” means gearing that reduces an input speed to a slower output speed. In some embodiments, reduction gears having a planetary arrangement are used to drive rotation of the rollers 121, 122. As used herein, the term “planetary gearset” refers to a gearset in which all of the gears are in one plane, grouped around each other like the planets around the sun. The central gear is called the “sun gear.” In mesh with it is a circular grouping of gears, called “planet gears,” mounted on a rotating carrier. The planet gears also engage teeth on the inner periphery of the “ring gear.” By holding any one of the three gear elements motionless, different ratios can be produced between the other two. In other embodiments, reduction gears having a compound arrangement are used to drive rotation of the rollers 121, 122. As used herein, the term “compound gearset” means a gearset in which two or more gears are fixed on the same shaft.

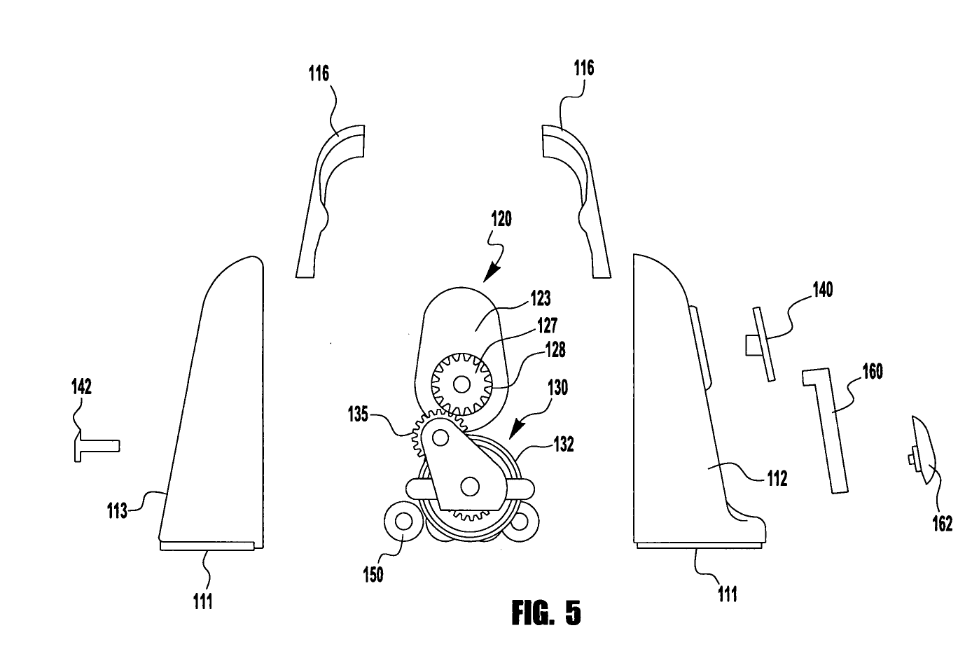

When the electric motor 132 is activated and the output shaft of the electric motor 132 rotates, a cylindrical gear mounted on the output shaft rotates and drives the main gear of the gear assembly 135. In the illustrated embodiment, the main gear is mechanically connected with the gear assembly 127 of the roller cartridge 120. The main gear, together with the gear assembly receiver portion of the rollers 121, 122, transfer the rotational motion of the cylindrical gear mounted on the output shaft of the electric motor 132 to the pair of rollers 121, 122. Accordingly, as the cylindrical gear turns, the main gear of the gear assembly 135 turns; as the main gear turns, each of the one or more additional step gears are driven to rotate, and in turn, the gear assembly receiver portion of the pair of rollers 121, 122 is driven to rotate. The number, sizes, and ratios of the gears in the gear assembly 135 influence whether the rate of rotation of rollers 121, 122 is the same as or different from the rate of rotation of the output shaft of the electric motor 132. Good results have been obtained using step gears according to the embodiment illustrated in FIG. 5, where the step gear engages with a gear receive portion on the rollers 121, 122, and where the gear ratios are 216:1. It should be apparent to one skilled in the art that additional embodiments of the paper detailer could include a variety of gear ratios. In some embodiments, the gear assembly comprises one or more washers, one or more supports, and one or more bushings (not shown), which serve to support and aid in smooth rotation of the rollers 121, 122 within the gear assembly 135. Of course, other combinations of gears and other gear ratios can be used with a variety of gear assemblies together with a variety of different motors having selected motor specifications and power source output, wherein the combination of such factors provides torque and rotational speeds for the rollers in the ranges recited herein.

The detailer 100 of the illustrated embodiment includes a forward activation switch 140 and a reverse activation switch 142 (connected to the electrical motor 132 by wires not shown). In the illustrated embodiment, the forward activation switch 140 is mounted within the front wall 112 of the housing 110 and the reverse activation switch 142 is mounted within the back wall 113 of the housing 110. The location and orientation of the forward and reverse activation switches 140, 142 of the illustrated embodiment are adapted to allow a user to easily grasp the detailer 100 and manipulate both the forward and reverse activation switches with the same hand. However, it should be apparent to one skilled in the art that the switches 140, 142 could be mounted to the housing or other portion of the detailer 100 in different places. In addition, it should be apparent that the forward and reverse activation switches 140, 142 are optional and need not be included with all embodiments of the detailer 100.

When a user wishes to feed paper or other material into the detailer 100, the forward activation switch 140 is pressed, which activates the electric motor 132 and causes the top roller 121 to rotate in a counter-clockwise manner and the bottom roller 122 to rotate in a clockwise manner, i.e. when viewed from the right side in FIG. 1, thereby pulling the paper or other material into the detailer through the opening 117. Conversely, when a user wishes to eject paper or other material out from the detailer 100, the reverse activation switch 142 is pressed, which activates the electric motor 132 and causes the top roller 121 to rotate in a clockwise manner and the bottom roller 122 to rotate in a counter-clockwise manner, i.e. when viewed from the right side in FIG. 1, thereby ejecting the paper or other material from the detailer. In the illustrated embodiment, the reverse activation switch 142 only activates the electric motor 132 when the forward activation switch 140 is simultaneously pressed; however, it should be apparent that the switches could activate the electric motor independently of each other in additional embodiments. It should also be apparent to one skilled in the art that the direction of the rotation of the rollers 121,122 could be different in additional embodiments and that it is also not necessary for both of the rollers to be driven by the electric motor.

In the illustrated embodiment, the switches 140, 142 are momentary switches but many different types of switches could be used. The electric motor 132 continues to run until the momentary switch 140 is released. However, alternative embodiments may include switches that do not have to be continuously pressed to activate the electric motor 140. It should be apparent to those skilled in the art that the present invention could include many different types of switches. For example, the detailer 100 could include an automatic start mechanism which would activate the electric motor 132 when a piece of paper or other material comes within a predetermined distance of the rollers 121, 122. Finally, additional embodiment of the detailer may not include a reverse activation switch.

The detailer 100 of the illustrated embodiment includes four 1.5 volt AA alkaline batteries 150 that are supported and enclosed within the housing 110. The batteries 150 are electronically connected with the electric motor 132 and the activation switches 140, 142 of the detailer by wires not shown and they power the electric motor. Different types and numbers of batteries could be effectively used. The detailer 100 could also be powered by other power sources, for example the detailer of the present invention could be adapted to be powered by standard household electrical current or a direct current power sources, such as a vehicle's cigarette lighter. In addition, the detailer 100 could also be manually powered by a hand-crank or other device.

In the illustrated embodiment, the housing includes an optional paper feeder 160 with a paper guide 162. In the illustrated embodiment, the paper feeder 160 is a generally planar member that is pivotally mounted to the housing 110 and may be selectively flipped up and locked in a position that is generally perpendicular to the housing 110. The optional paper feeder 160 supports the weight of the paper or other material that is being fed into the detailer 100 and assists the user in feeding the paper or other material into the detailer. By supporting the weight of the paper or other material, the paper feeder 160 helps to ensure that the pattern or design will be clearly and evenly rendered onto the paper or other material.

The optional paper guide 162 of the illustrated embodiment is mounted within a groove 164 defined within the paper feeder 160 and is selectively moveable within the groove 164 to accommodate various shapes and sizes of paper or other material. The paper guide 162 may be aligned with the edge of the paper or other material being inserted into the detailer 100 by the user to ensure that the paper or other material enters the detailer 100 properly and does not become crooked when entering the detailer 100. In the illustrated embodiment, a portion of the cover 116 is translucent so as to allow the user to see the rollers and thereby line up a piece of paper or other material in coordination with the rollers so as to cut a strip of paper of a desired width or imprint an embossment or crimp on a certain portion of a piece of paper or other material. It should be apparent to one skilled in the art, that the paper feeder 160 and paper guide 162 are not limited to the shape and configuration shown in the illustrated embodiment but could be shaped and configured differently. For example, the paper feeder 160 could simply be an opening defined within the housing 110 that included a surface the paper or other material being fed into the detailer could rest on. In addition, it should be apparent that the paper feeder 160 and paper guide 162 are optional and need not be included with all embodiments of the detailer 100. Optionally, various embodiment of the detailer 100 could also include a blade or other cutting device to cut the paper to a desired length once it exits the detailer 100.

In use, the user mounts the desired roller cartridge 120 into the housing 110, the pair of rollers 121, 122 including a template desired by the user. The user then feeds a piece of paper, a photo or other material between the rollers 121, 122. The powered rollers 121, 122 roll the paper/photo through the paper detailer 100. The forces of the rollers 121, 122 transfer the design of the template onto/into the paper/photo. Thus, the paper receives a crimp, embossment, texture, or cut corresponding to the pair of rollers installed by the user. Thus, the illustrated embodiment of the present invention is a portable, easy-to-use, battery-operated paper detailer used mainly in crafts and scrapbooking, but suitable for other similar uses.

It will be understood by those skilled in the art that while the foregoing description sets forth in detail preferred embodiments of the present invention, modifications, additions, and changes might be made thereto without departing from the spirit and scope of the invention.

The invention claimed is:

1. A media detailer, comprising:
a housing;
an electric motor;
a pair of rollers rotatably supported substantially within the housing and operatively connected with the electric motor, wherein the pair of rollers are substantially parallel to each other and at least one of the rollers includes a template, wherein the pair of rollers are adapted to render or transfer a pattern formed by the template when a piece of paper or other material is rolled between the rollers; and
a power source electrically connected to the electric motor.

2. A media detailer, comprising:
a housing; and
a roller cartridge supportable by the housing, the roller cartridge including a pair of rollers rotatably supported within the roller cartridge; wherein the pair of rollers are substantially parallel to each other and at least one of the rollers includes a template; wherein the pair of rollers are adapted to render or transfer a pattern formed by the template when a piece of paper or other material is rolled between the rollers; and wherein the roller cartridge is adapted for engagement with a drive mechanism.

3. The media detailer of claim 2 wherein the drive mechanism is selected from a manually operated hand crank and an electric motor.

4. The media detailer of claim 3 wherein the drive mechanism is an electric motor and further comprises a power source for supplying power to the electric motor, the power source being selected from at least one battery and an alternative current adapter for use with standard U.S. household current.

5. The media detailer of claim 1 further comprising an activation switch operatively connected to the electric motor for activating the electric motor; wherein the activation switch is located on an outside surface of the housing.

6. The media detailer of claim 1 wherein the electric motor has a forward activation state and a reverse activation state, the media detailer further comprising a first and second activation switch operatively connected to the electric motor for activating the electric motor; wherein the activation switches are located on an outside surface of the housing; and wherein the first activation switch activates the electric motor in the forward activation state and the second activation switch activates the electric motor in the reverse activation state.

7. The media detailer of claim 1 wherein the pair of rollers includes at least one crimping roller.

8. The media detailer of claim 1 wherein the pair of rollers includes at least one embossing roller.

9. The media detailer of claim 1 wherein the pair of rollers includes at least one die-cutting roller.

10. The media detailer of claim 1 wherein the pair of rollers includes at least one die-cutting roller.

11. The media detailer of claim 1 wherein at least one of the rollers includes at least one cutting blade.

12. The media detailer of claim 1 wherein the electric motor produces an output of generally between 12,000 and 20,000 revolutions per minute.

13. The media detailer of claim 12 wherein the electric motor produces an output of generally between 14,000 and 17,000 revolutions per minute.

14. The media detailer of claim 13 wherein the electric motor produces an output of generally 15,720 revolutions per minute.

15. The media detailer of claim 2 wherein the roller cartridge is removable from the housing.

16. A media detailer, comprising:
a housing; and
a pair of rollers rotatably supported by the housing, wherein the pair of rollers are substantially parallel to each other; wherein one of the rollers includes one or more cutting blades and the other of the pair of rollers has a padded surface.

17. The media detailer of claim 16 further comprising an electric motor and a power source for supplying power to the electric motor.

18. The media detailer of claim 17 wherein the power source comprises at least one battery.

19. The media detailer of claim 17 wherein the power source comprises:
an alternating current adapter for use with standard U.S. household current; and
a power cord having a plug for insertion into standard household electric receptacle.

20. The media detailer of claim 17 further comprising an activation switch operatively connected to the electric motor for activating the electric motor; wherein the activation switch is located on an outside surface of the housing.

21. The media detailer of claim 17 wherein the electric motor has a forward activation state and a reverse activation state, the media detailer further comprising a first and second activation switch operatively connected to the electric motor for activating the electric motor; wherein the activation switches are located on an outside surface of the housing; and wherein the first activation switch activates the electric motor in the forward activation state and the second activation switch activates the electric motor in the reverse activation state.

22. The media detailer of claim 16 wherein at least one of the rollers includes a single cutting blade.

23. The media detailer of claim 16 wherein at least one of the rollers includes multiple cutting blades.

24. A media detailer, comprising:
a housing;
an electric motor;
a roller cartridge housing;
a pair of rollers rotatably supported within the roller cartridge housing; wherein the pair of rollers are substantially parallel to each other and at least one of the pair of rollers includes a template; and wherein the pair of rollers are adapted to render or transfer a pattern formed by the template when a piece of paper or other material is rolled between the rollers; and
a gearing assembly, the gearing assembly being operatively connected with the pair of rollers and engageable with the electric motor, which in cooperation with the gearing assembly drives the pair of rollers.
